(19) United States
(12) Patent Application Publication
(10) Pub. No.: US 2018/0032947 A1
(43) Pub. Date: Feb. 1, 2018

(54) PRODUCT SHELF LAYOUT DESIGN DEVICE

(71) Applicant: HITACHI TRANSPORT SYSTEM, LTD., Tokyo (JP)

(72) Inventors: Satoshi Nagahara, Tokyo (JP); Issei Suemitsu, Tokyo (JP)

(73) Assignee: HITACHI TRANSPORT SYSTEM, LTD., Tokyo (JP)

(21) Appl. No.: 15/553,009

(22) PCT Filed: Feb. 26, 2015
(86) PCT No.: PCT/JP2015/055531

§ 371 Date: Aug. 23, 2017

(51) Int. Cl. G06Q 10/08; G06Q 10/06

(52) U.S. Cl. CPC G06Q 10/087; G06Q 10/06311

(57) ABSTRACT

A product shelf layout design device, in generating each of a plurality of product shelf layout design drafts, includes a product shelf group, a product allotment, a maximum storage amount, and resupply point in the product shelf layout design draft, calculates picking operation man-hours of each of the plurality of product shelf layout design drafts, calculates resupplying operation man-hours of each of the plurality of product shelf layout design drafts, and selects a product shelf layout design based on the picking operation man-hours and the resupplying operation man-hours of each of the plurality of product shelf layout design drafts.

### BACKGROUND OF THE INVENTION

The present invention relates to a product shelf layout design device.

One task involved in physical distribution is a picking operation in which a worker gathers designated products while cycling through product shelves in a picking area. In reducing man-hours during a picking operation, the product shelves arranged in the picking area and the allotment of products in each product shelf are important factors.

JP 2014-34442 A (Patent Document 1) discloses a product shelf layout technique that focuses on the frequency of delivery and the motion line distance for workers when shipping out products.

### SUMMARY OF THE INVENTION

In the patent document, regarding the picking operation, only the frequency of delivery and the motion line distance for delivery are considered, and product allotment is not made in consideration of resupply operations.

Regarding a resupply operation, there is a method in which, if the amount of a product stocked on a product shelf decreases to below a threshold (resupply point), then the product is resupplied to a quantity that is set in advance (maximum stock amount). In this method, the frequency of the resupply operation is determined by the maximum stock amount of each product and the resupply point. Thus, the greater the maximum stock amount of the product is, the greater the degree to which the product can be resupplied in one resupply operation is, and the lower the resupply operation frequency is.

However, in order to increase the maximum stock amount of each product, a larger picking area and more product shelves would be required, which would increase area costs and equipment costs. Also, the total motion line distance including the motion line distance during the picking operation and the motion line during the resupply operation become long, which increases the man-hours required for the operation, resulting in an increase in operation costs. In this manner, if the maximum stock amount is increased only in consideration of decreasing the frequency of resupply, the operation costs would increase.

An object of the present invention is to decrease physical distribution costs.

The aspect of the present invention adopts the following configuration for solving the above problems. A product shelf layout design device, comprising: a processor; and a storage device, wherein the storage device stores delivery performance information identifying a delivery date, a round, a product, and a delivery amount, product size information identifying a product size, product shelf information identifying a storage size of a product shelf, picking area information identifying an arrangement in a picking area, and a parameter that converts a motion line distance to a movement time, and wherein the processor generates a product shelf group draft necessary for storing the product, a product allotment draft for the product shelf group draft, and a maximum storage amount and resupply point draft for the product using the delivery performance information over a prescribed period, the product size information, and the product shelf information, generates a shelf arrangement draft and a motion line distance between shelves for a product shelf group using the product shelf group draft necessary for storing the product, and the picking area information, generates a plurality of the product shelf layout drafts that are a combination of the product allotment draft, the maximum storage amount and resupply point draft for the product, and the shelf arrangement draft, calculates, for the product shelf layout draft, a pickup operation time in a delivery performance over the prescribed period using the delivery performance information of the prescribed period, the motion line distance between shelves, and the parameter, calculates, for the product shelf layout draft, calculate a resupply operation time based on the delivery performance over the prescribed period using the delivery performance information of the prescribed period, the motion line distance between shelves, and the parameter, calculates operation man-hours using the pickup operation time and the resupply operation time, and selects a product shelf layout draft to be displayed from among the plurality of product shelf layout drafts using the operation man-hours.

According to the present invention it is possible to decrease physical distribution costs.

### BRIEF DESCRIPTION OF THE DRAWINGS

The present invention can be appreciated by the description which follows in conjunction with the following figures, wherein:

FIG. 1 is a schematic diagram depicting an example of a picking area;

FIG. 2 is a schematic diagram depicting an example of a product shelf layout design system;

FIG. 3 is a block diagram depicting a configuration example of a product shelf layout design device;

FIG. 4 shows an example of a delivery performance information table;

FIG. 5 shows an example of a product size information table;

FIG. 6 shows an example of a shelf information table;

FIG. 7 shows an example of a picking area information table;

FIG. 8 shows an example of a unit cost information table;

FIG. 9 shows an example of a parameter information table;

FIG. 10 shows an example of a shelf arrangement information table;

FIG. 11 shows an example of a product allotment information table;

FIG. 12 shows an example of a total cost information table;

FIG. 13 is a flowchart depicting an example of a process for product shelf layout design;

FIG. 14 shows an example of an updated picking area information table;

FIG. 15 is a flowchart depicting an example of the picking operation man-hour and resupply operation man-hour calculation processes;

FIG. 16 shows an example of a display screen for setting input data; and

FIG. 17 shows an example of a display screen of a product shelf layout draft.

### DETAILED DESCRIPTION OF EMBODIMENTS

An embodiment of the present invention will be explained below with reference to attached drawings. The embodiment is merely an example for realizing the present invention, and the embodiment does not limit the technical scope of the present invention.

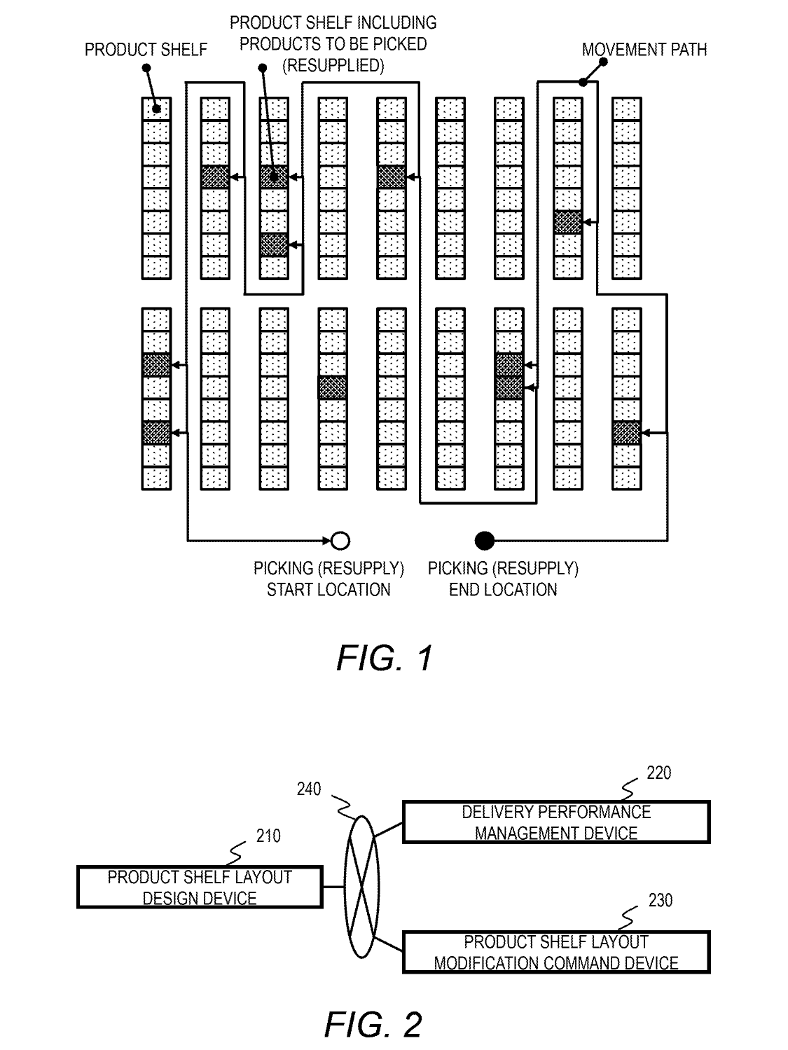

FIG. 1 shows an example of a schematic view of a picking area. The picking area has a plurality of product shelves, and each product shelf has products allocated thereto. The pick-up worker starts at a picking start point and cycles about the product shelves to find the products to be picked up and picks up the products. Once all products have been picked up, the pick-up worker moves to the picking end point. Also, if the stock amount for each product decreases to below a resupply point, a resupply worker picks up products from a backward storage shelf, moves from a resupply start point to the product shelf and resupplies the product shelf, and then moves to the resupply end point.

A product shelf layout design device of the present embodiment designs a product shelf layout draft that considers the above-mentioned picking operation and resupply operation, and provides this draft to the user. The provided product layout (draft) includes the arrangement of product shelves in the picking area, a product allotment that indicates the correspondence between the product shelves and the types of products to be stocked on the product shelves, a maximum stock amount of each product stocked on each product shelf in the product allotment, and a resupply point that indicates the stock amount at which resupply is necessary. In the present specification the “product shelf” is sometimes referred to simply as a “shelf”.

FIG. 2 shows a schematic view of a product shelf layout design system. The product shelf layout design system of the present embodiment includes a product shelf layout design device 210, a delivery performance management device 220, and a product shelf layout modification command device 230, and the devices transmit and receive information to/from each other through the network 240.

The delivery performance management device 220 receives input from an information terminal used during the picking operation and manages delivery performance information for prior picking operations. Also, the delivery performance management device 220 transmits delivery performance information to the product shelf layout design device 210 at a predetermined time or at the request of the product shelf layout design device 210. Furthermore, the product shelf layout design device 210 stores the received delivery performance information.

The product shelf layout modification command device 230 manages allotment modification command information for the product shelf layout.

Also, the product shelf layout modification command device 230 receives from the product shelf layout design device 210 a product shelf layout draft created by the product shelf layout design device 210 at a predetermined time or at the request of the product shelf layout design device 210.

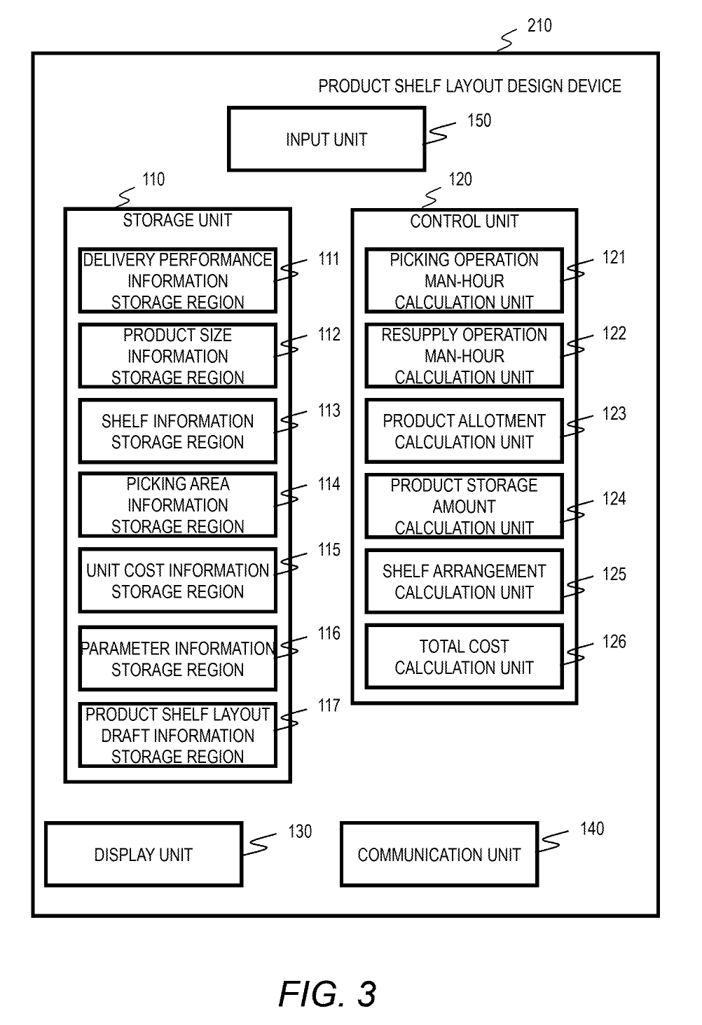

FIG. 3 shows a configuration example (block diagram) of the product shelf layout design device 210. The product shelf layout design device 210 includes a storage unit 110, a control unit 120, a display unit 130, a communication unit 140, and an input unit 150. These are typically constituted of general use computers that execute programs. Specifically, the storage unit 110 is a storage device, the control unit 120 is a processor that operates in conjunction with software, the display unit 130 is a display, the communication unit 140 is a LAN connection device, and the input unit 150 is a keyboard and/or a mouse. Each process performed by the control unit 120 is technically realized by the processor operating in conjunction with the programs, but in the present specification, for ease of description, the processor will be described as performing the processes.

The storage unit 110 includes a delivery performance information storage region 111, a product size information storage region 112, a shelf information storage region 113, a picking area information storage region 114, a unit cost information storage region 115, a parameter information storage region 116, and a product shelf layout draft information storage region 117.

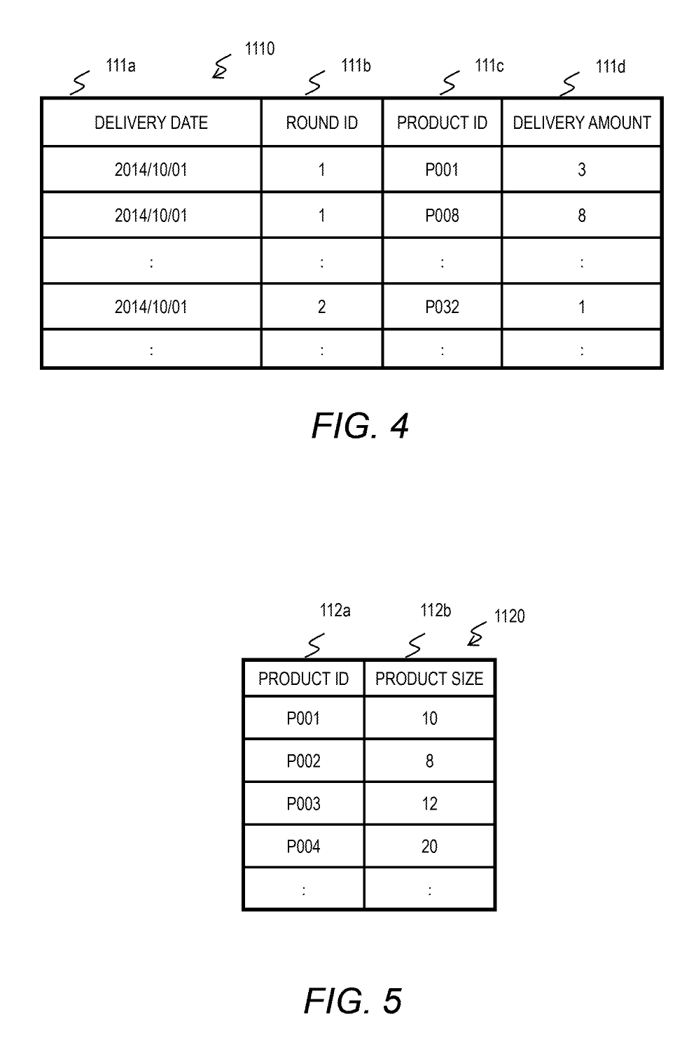

The delivery performance information storage region 111 stores information specifying prior picking operation performance. The delivery performance information storage region 111 stores a delivery performance information table 1110 shown in FIG. 4, for example. The delivery performance information table 1110 includes a delivery date column 111a, a round ID column 111b, a product ID column 111c, and a delivery amount column 111d.

The delivery date column 111a stores the delivery date. Information including the delivery date or the delivery date and time is stored therein, for example. The round ID column 111b stores information identifying the round. The round ID is identification information assigned to each round, and because, in the present embodiment, this ID is used to identify the order of rounds as well, a number is used therefor. The product ID column 111c stores information identifying the product retrieved during the round. The delivery amount column 111d stores information identifying the number of product items retrieved during the round.

The product size information storage region 112 stores information identifying the size information of each product. The product size information storage region 112 stores a product size information table 1120 shown in FIG. 5, for example. The product size information table 1120 includes a product ID column 112a, and a product size column 112b. The product ID column 112a stores information identifying the product. The product size column 112b stores information identifying the size of each product. If a plurality of items of a product are treated as one unit, then each unit is virtually treated as one product.

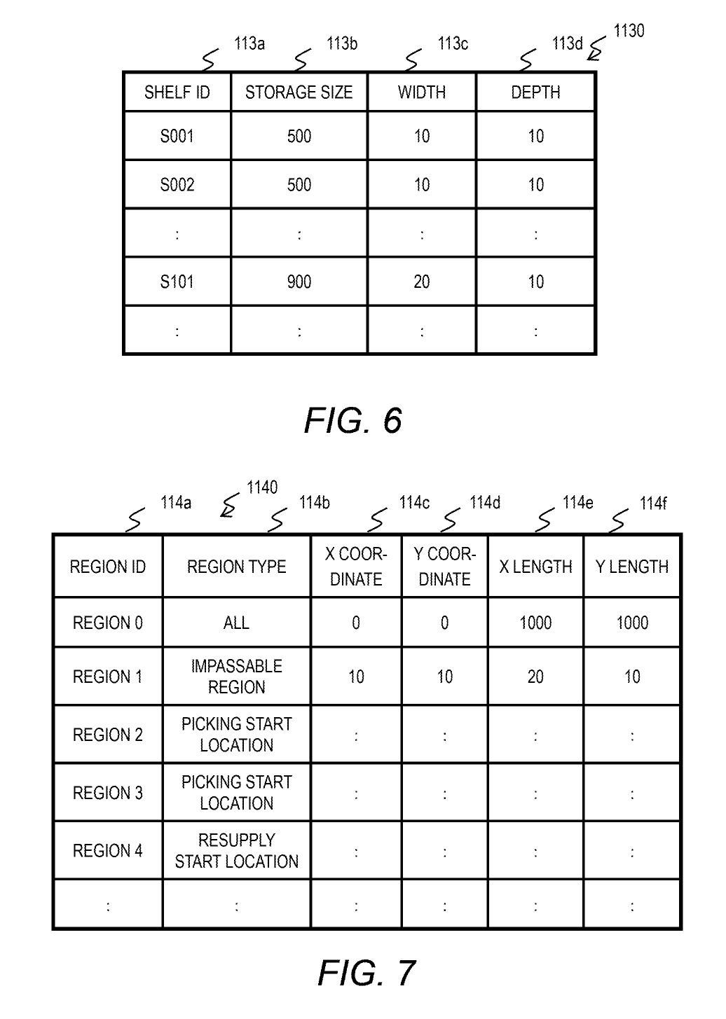

The product size is the typical size of the product itself (the volume indicated by the length, width, height, etc., for example). However, in cases in which the size is difficult to indicate such as if the product is not a rectangular cuboid or a cube, a bounding box into which the product is packed may be provided and the size of the box may be indicated. The shelf information storage region 113 stores information identifying the storage size of each product shelf. The shelf information storage region 113 stores a shelf information table 1130 shown in FIG. 6, for example. The shelf information table 1130 includes a shelf ID column 113a, a storage size column 113b, a width column 113c, and a depth column 113d. The shelf ID column 113a stores information identifying the product shelf.

The storage size column 113b stores information identifying the storage size of each product shelf. Internal volume is an example of information identifying the storage size. The width column 113c stores information identifying the width taken up by each product shelf. The depth column 113d stores information identifying the depth taken up by each product shelf. The width and depth of the product shelves is an example of size information of the product shelves, and may be information identifying the size of the product shelves.

The picking area information storage region 114 stores information on the entire picking area and each region. Information identifying the entire picking area, impassable regions, the picking start point, the picking end point, the resupply operation start point, and the resupply operation end point is stored, for example.

The picking area information storage region 114 stores a picking area information table 1140 shown in FIG. 7, for example. The picking area information table 1140 includes a region ID column 114a, a region type column 114b, an X coordinate column 114c, a Y coordinate column 114d, an X length column 114e, and a Y length column 114f, for example.

The region ID column 114a stores information identifying each region in the picking area. The region type column 114b stores information identifying the type of each region. Information stored as the region type includes, for example, “all”, which indicates the entire picking area region; an “impassable region”, which indicates regions where workers are not allowed to pass; a “picking start point”; a “picking end point”; a “resupply operation start point”; a “resupply operation end point”; and the like. The X coordinate column 114c and the Y coordinate column 114d map the picking area into a two-dimensional plane, and store information identifying the representative coordinates of each region in a coordinate space defined according to an X axis and a Y axis, which are perpendicular to each other. If, for example, the representative coordinate of a certain region is the top left of that region, then the X coordinate and Y coordinate of the top left of that region are respectively stored. The X length column 114e and the Y length column 114f are pieces of information identifying the lengths in the respective axial directions.

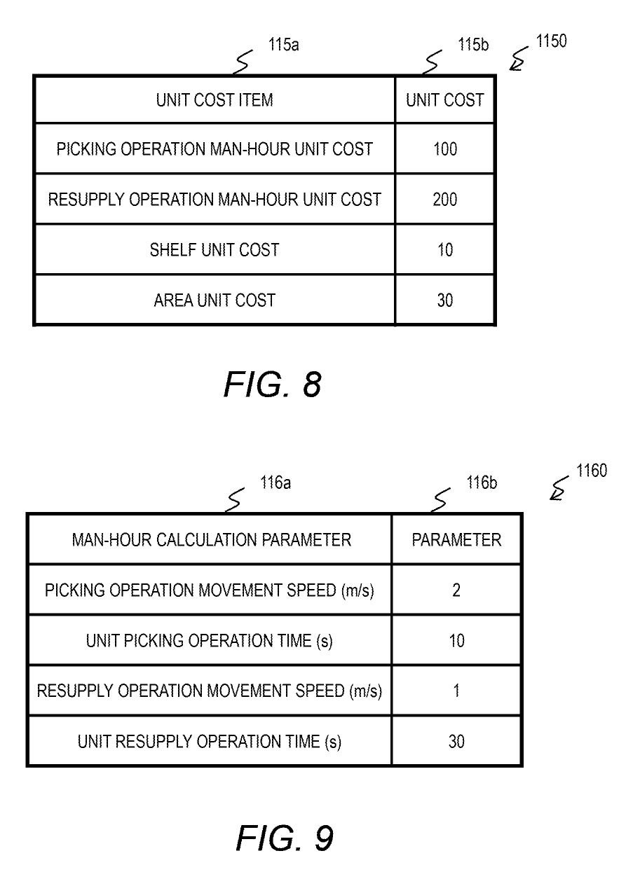

The unit cost information storage region 115 stores information identifying the unit cost in order to calculate costs such as operation costs, equipment costs, and area costs. The unit cost information storage region 115 stores a unit cost information table 1150 shown in FIG. 8, for example. The unit cost information table 1150 includes a unit cost item column 115a and a unit cost column 115b. The unit cost item column 115a stores information identifying the unit cost item.

The unit cost item column 115a stores unit cost items (cost items) including the operation cost per man-hour in the picking operation (unit cost per picking operation man-hour), the operation cost per man-hour in the resupply operation (unit cost per resupply operation man-hour), the equipment cost per shelf (shelf unit cost), and the area cost per unit area of the picking area (area unit cost). The unit cost column 115b stores information identifying the unit cost of each item. The unit cost per picking operation man-hour/unit cost per resupply operation man-hour may differ for each picked/resupplied product, and the shelf unit cost may differ for each shelf. In such a case, the unit cost may be set for each product ID or shelf ID.

The parameter information storage region 116 stores information identifying each parameter used when calculating the man-hours in a picking operation man-hour calculation process, a resupply operation man-hour calculation process, and the like, which will be mentioned later. The parameter information storage region 116 stores a parameter information table 1160 shown in FIG. 9, for example. The parameter information table 1160 includes a man-hour calculation parameter column 116a and a parameter value column 116b.

The man-hour calculation parameter column 116a stores information identifying the parameter items used in the man-hour calculation process. The man-hour calculation parameter column 116a stores parameter items such as the movement speed during the picking operation (picking operation movement speed), the unit operation time during the picking operation (unit picking operation time), the movement speed during the resupply operation (resupply operation movement speed), and the unit resupply operation time during the resupply operation, for example. The parameter value column 116b stores information identifying the value of the man-hour calculation parameter column 116a.

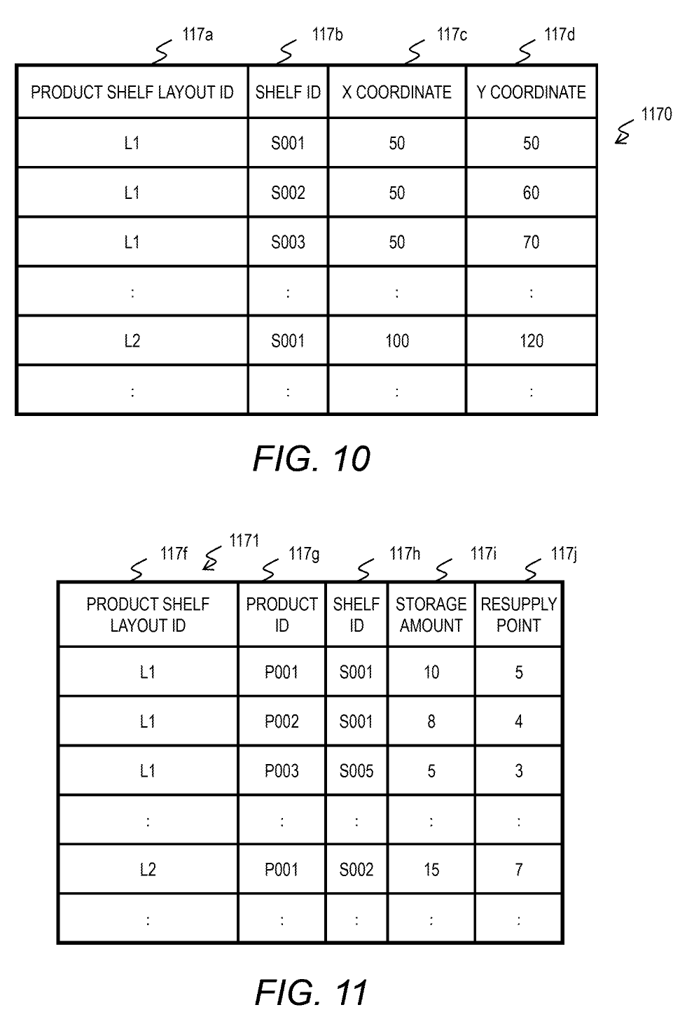

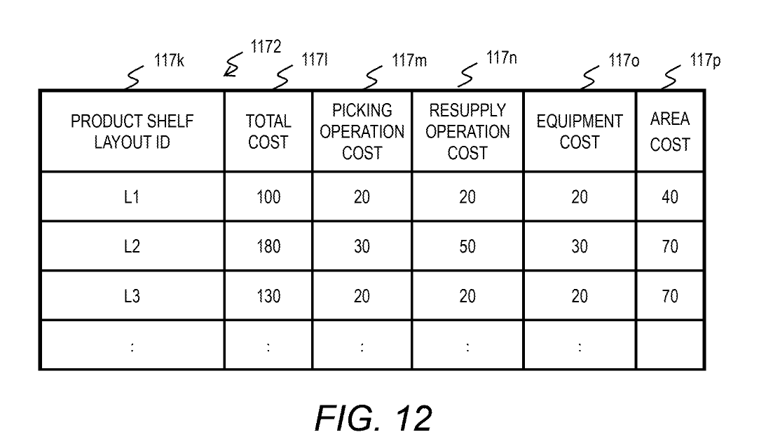

The product shelf layout draft information storage region 117 stores information identifying the product shelf layout draft generated by the control unit 120. The product shelf layout draft information storage region 117 stores a shelf arrangement information table 1170 shown in FIG. 10, a product allotment information table 1171 shown in FIG. 11, a total cost information table 1172 shown in FIG. 12, for example.

The shelf arrangement information table 1170 includes a product shelf layout ID column 117a, a shelf ID column 117b, an X coordinate column 117c, and a Y coordinate column 117d. The product shelf layout ID column 117a stores information identifying the product shelf layout draft. The shelf ID column 117b stores information identifying the product shelf.

The X coordinate column 117c and the Y coordinate column 117d store information identifying the arrangement coordinates of the product shelves in the product shelf layout draft.

The product allotment information table 1171 includes a product shelf layout ID column 117f, a product ID column 117g, a shelf ID column 117h, a maximum storage amount column 117i, and a resupply point column 117j. The product shelf layout ID column 117f stores information identifying the product shelf layout draft. The product ID column 117g stores information identifying the product. The shelf ID column 117h stores information identifying the product shelves to which the products are allotted in the product shelf layout draft. The maximum storage amount column 117i stores information identifying the maximum storage amount of each product shelf for products in the product shelf layout draft. The resupply point column 117j stores information identifying the resupply points for the products in the product shelf layout draft.

The total cost information table 1172 includes a product shelf layout ID column 117k, a total cost column 117l, a picking operation cost column 117m, a resupply operation cost column 117n, an equipment cost column 117o, and an area cost column 117p. The product shelf layout ID column 117k stores information identifying the product shelf layout draft. The total cost column 117l stores information identifying the total cost in the product shelf layout. The picking operation cost column 117m stores information identifying the picking operation cost in the product shelf layout. The resupply operation cost column 117n stores information identifying the resupply operation cost in the product shelf layout. The equipment cost column 117o stores information identifying the equipment cost in the product shelf layout. The area cost column 117p stores information identifying the area cost in the product shelf layout.

The functions of each unit of the control unit 120 are realized by the program in conjunction with a computer system, and in particular, the processor.

Below, the functions of the respective units of the control unit 120 will be described as process flows of the control unit 120.

The display unit 130 outputs information stored in the storage unit 110. The display unit 130 displays information stored in the product shelf layout draft information storage region 117, for example.

The communication unit 140 transmits/receives information with other devices and the like through the network 240.

The input unit 150 receives input by the user or the like.

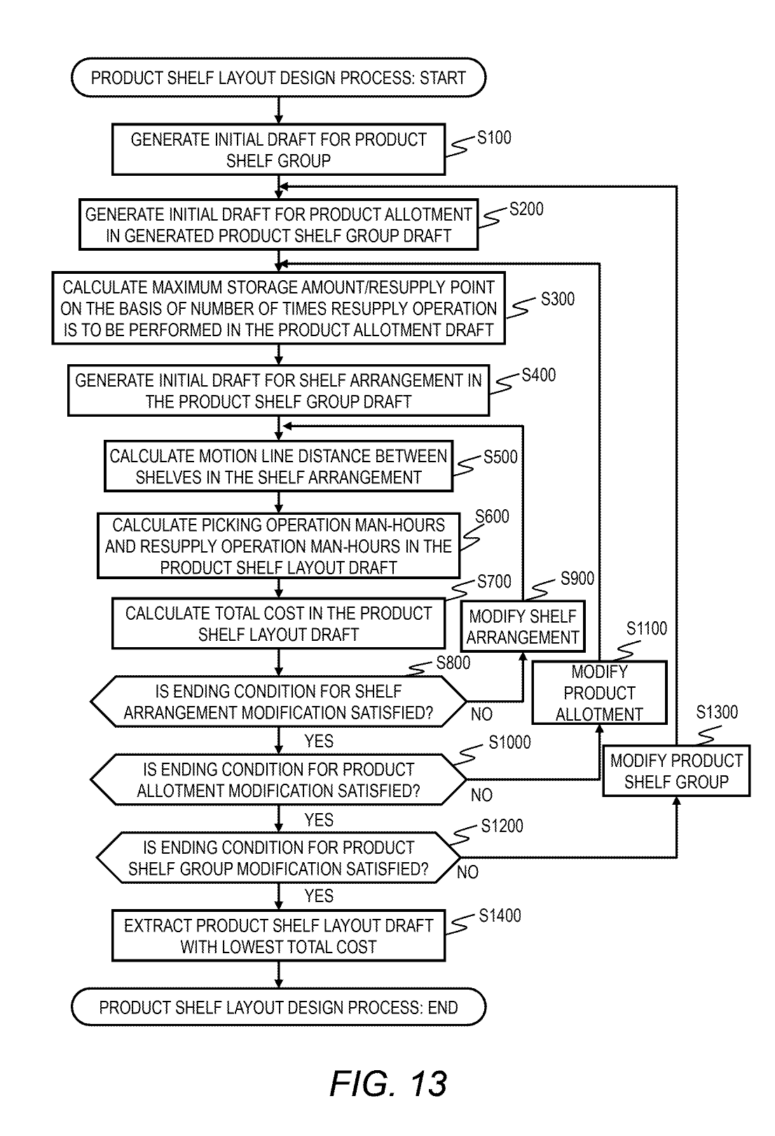

FIG. 13 shows an example of a process for product shelf layout design.

A shelf arrangement calculation unit 125 generates an initial draft of a group of product shelves used in the product shelf layout draft (S100).

The shelf arrangement calculation unit 125 calculates the daily average delivery amount of each product according to the delivery dates and delivery amounts acquired from the delivery performance information table 1110 (delivery performance information storage region 111) of FIG. 4, and multiplies this average by N to calculate the delivery amount for N days, for example. Next, the shelf arrangement calculation unit 125 calculates values by multiplying the N-day delivery amounts for respective products by the product sizes acquired from the product size information table 1120 of FIG. 5 and adds up the values, thereby calculating the total storage size necessary to store N days' worth of the product.

The shelf arrangement calculation unit 125 randomly selects one shelf at a time from the shelf information table 1130 until the total storage size, which is calculated by adding up the storage sizes of the respective product shelves included in the product shelf group draft, exceeds the total storage size necessary to store N days' worth of the product, thereby generating an initial product shelf group draft. N need not necessarily be an integer of 1 or greater, and any value greater than 0, such as “0.5” for a half day, may be used.

A product allotment calculation unit 123 generates an initial draft of product allotment to each shelf in the product shelf group draft (S200). The product allotment calculation unit 123 allots one type of product at a time, included in the delivery performance information table 1110 of FIG. 4, to each product shelf in the product shelf group, for example. The allotment method may be random. Also, one type of product may be allotted to a plurality of product shelves.

The product allotment calculation unit 123 allots all products to the product shelves (determines the product allotment) within a range in which the total size of the products to be allotted to each product shelf does not exceed the storage size of the product shelf.

If the storage size of the product shelf does not exactly accommodate the size of n items of a product, this results in dead space, which means that not all of the product can be stored. To handle this issue, if the total size of the products to be allotted to the product shelf and of products already allotted to the product shelf exceeds the storage size of the product shelf, then the product allotment calculation unit 123 issues a request to the shelf arrangement calculation unit 125 to add shelves to the product shelf group draft. The shelf arrangement calculation unit 125, upon receiving the request, adds a product shelf from the shelf information table 1130 to the product shelf group draft, and notifies the product allotment calculation unit 123 that the addition of the shelf has been completed. The product allotment calculation unit 123 continues the process and allots the products to the added product shelf.

A resupply operation man-hour calculation unit 122 calculates the number of times to perform the resupply operation in the product allotment draft, and calculates the maximum storage amount and resupply point of each product on the basis of the number of times to perform the resupply operation (S300).

First, the resupply operation man-hour calculation unit 122 sets a combination of a given maximum storage amount column and a given resupply point (less than or equal to maximum storage amount).

The resupply operation man-hour calculation unit 122 sets the initial value of the product storage amount as the maximum storage amount, and subtracts the delivery amounts in the row corresponding to the product of the delivery performance information table 1110 successively from the product storage amount. If the product is allotted to a plurality of product shelves, then the resupply operation man-hour calculation unit 122 may subtract the products from a randomly selected product shelf from among the plurality of product shelves, subtract the products from a product shelf with the maximum storage amount for products, or subtract the products from a product shelf in which the difference between the product storage amount and the resupply point is the greatest. If, as a result of subtraction, the product storage amount decreases to below the resupply point, then the number of times to perform the resupply operation is increased by one, and the product storage amount is reverted to the maximum storage amount.

The timing at which the product storage amount is reverted to the maximum storage amount may be the end time for the round at which the product storage amount decreased to below the resupply point or the batch end time that includes the round. A batch is a unit in which at least one round is managed, and the above process can be performed if the delivery performance information storage region 111 additionally stores information that places the round and the batch in correspondence with each other. By the process being repeated for all rows in the delivery performance information table 1110, the number of times to perform the resupply operation for the product is calculated.

In some cases, when the delivery amount is subtracted from the product storage amount, the product storage amount decreases to below 0. Specifically, if the storage amount is not less than the resupply point but the delivery amount exceeds the storage amount, and resupply is performed in batches, for example, then the storage amount sometimes decreases to below 0 prior to the batch end time. If the product storage amount decreases to below 0, then the picking operation might be interrupted. Thus, in such a case, the resupply operation man-hour calculation unit 122 resupplies the product immediately before the start of a picking operation that would result in the storage amount decreasing to below 0, for example. In calculating the number of times to perform the resupply operation, the resupply operation man-hour calculation unit 122 may distinguish between a resupply operation for when the product storage amount has decreased to below the resupply point, and a resupply operation for when the product storage amount is expected to decrease below 0. In such a case, during the process of step S605 to be mentioned later, the resupply operation man-hour calculation unit 122 may calculate the resupply operation man-hours by multiplying different coefficients to the number of times to perform each resupply operation depending on the distinguished resupply operations. Details will be mentioned later in step S605.

The resupply operation man-hour calculation unit 122 repeatedly combines and modifies the maximum storage amount and the resupply point for each product and executes the process of calculating the number of times to resupply, and derives the maximum storage amount and resupply point of each product such that the total number of times to resupply each product is at or below a prescribed number (preferably below), for example.

The shelf arrangement calculation unit 125 generates an initial draft of a shelf arrangement (S400). The shelf arrangement calculation unit 125 selects one shelf for which the arrangement is undecided among the product shelf group selected in step S100, for example. The shelf arrangement calculation unit 125 refers to the picking area information table 1140, takes into consideration (excludes) impassable regions, extracts the X coordinate and Y coordinate where the selected shelf can be arranged, and arranges the selected shelf. The shelf arrangement calculation unit 125 repeats the above process and generates an arrangement draft for product shelves in the product shelf group selected in step S100.

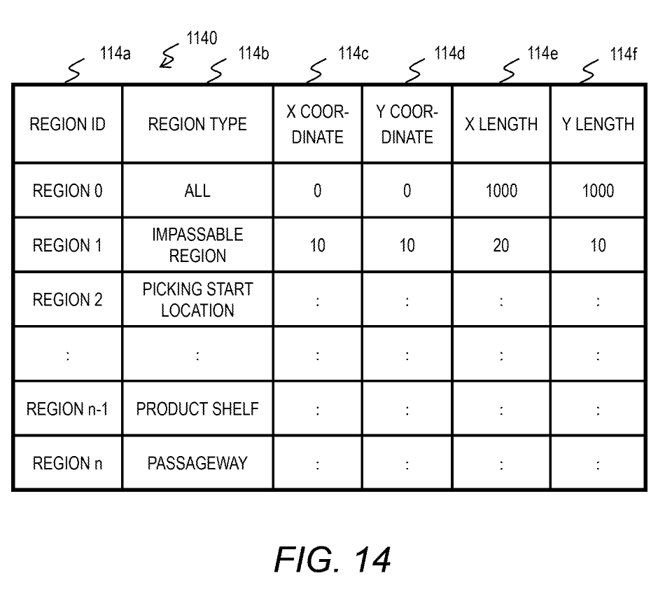

The shelf arrangement calculation unit 125 determines the picking area, which includes passageways, regions where the product shelves are arranged, and impassable regions from the information stored in the picking area information storage region 114 of FIG. 7 and the generated shelf arrangement draft, and as shown in FIG. 14 adds and stores information identifying a new picking area in the picking area information storage region 114.

The shelf arrangement calculation unit 125 calculates the motion line distance between each shelf in the shelf arrangement draft (S500). If the shelf arrangement calculation unit 125 calculates the motion line distance between a product shelf X and a product shelf Y, then on the basis of the information stored in the new picking area information storage region 114 shown in FIG. 14, for example, a path from the product shelf X to the product shelf Y (preferably the shortest path) that passes through passageways excluding impassable regions is set, and the motion line distance between shelves is calculated from the length of this path. As a method of calculating the shortest distance, Dijkstra's algorithm or the like may be used, for example.

Also, the shelf arrangement calculation unit 125 calculates not only the motion line distance between shelves but also calculates the motion line distance between each product shelf and the picking start point, between each shelf and the picking end point, between each shelf and the resupply operation start point, and between each shelf and the resupply operation end point.

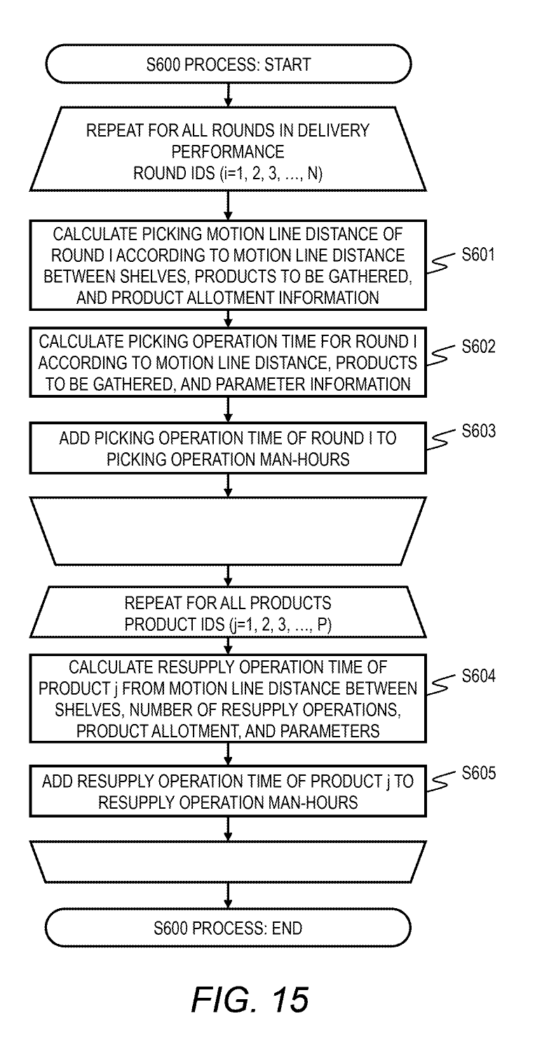

On the basis of the product shelf layout draft including the shelf arrangement, the product allotment, the maximum storage amount, and the resupply point determined in the process of steps S100 to S500, a picking operation man-hour calculation unit 121 calculates the picking operation man-hours and the resupply operation man-hour calculation unit 122 calculates the resupply operation man-hours (S600). Details of the picking operation man-hour calculation process and the resupply operation man-hour calculation process will be described later with reference to FIG. 15.

A total cost calculation unit 126 calculates the total cost in the product shelf layout draft (S700). The total cost calculation unit 126 acquires the picking operation man-hour unit cost, the resupply operation man-hour unit cost, the shelf unit cost, and the area unit cost from the unit cost information table 1150, for example. The total cost calculation unit 126 calculates the operation cost as the sum of a value attained by multiplying the picking operation man-hours calculated in step S600 by the picking operation man-hour unit cost, and a value attained by multiplying the resupply operation man-hours by the resupply operation unit cost. The total cost calculation unit 126 may set this sum itself as the operation cost, or may determine the operation cost by another calculation.

Also, the total cost calculation unit 126 calculates the equipment cost by multiplying the number of shelves in the product shelf layout draft by the shelf unit cost, for example. The total cost calculation unit 126 may set this value itself as the equipment cost. The total cost calculation unit 126 calculates the area cost by multiplying the area of the picking area by the area unit cost, for example. The total cost calculation unit 126 may set this value itself as the area cost. The total cost calculation unit 126 calculates the total cost by adding up the operation cost, the equipment cost, and the area cost, for example. The total cost calculation unit 126 may calculate the total cost by adding up only the operation cost and the equipment cost, instead of adding up the operation cost, the equipment cost, and the area Cost.

The shelf arrangement calculation unit 125 determines whether ending conditions for shelf arrangement draft modification are satisfied (800). If the shelf arrangement calculation unit 125 determines that the ending conditions are satisfied (S800: YES), then the process progresses to step S1000, and if not (S800: NO), then the process progresses to step S900. Examples of such ending conditions include the number of times that shelf arrangement modification is to be performed exceeding an upper limit value, a prescribed time elapsing from the start of the product layout design process, or the like.

The shelf arrangement calculation unit 125 modifies the shelf arrangement if the ending conditions are not satisfied (S900). The shelf arrangement calculation unit 125 modifies the shelf arrangement by moving one randomly selected shelf by a prescribed amount in the X direction or Y direction or interchanging the arrangement of two randomly selected shelves, for example, and generates a plurality of shelf arrangement drafts. The shelf arrangement calculation unit 125 may discard the modifications if, during the modifications, the arrangement position of the shelf to be modified is in the impassable region or in a position that is less than or equal to a prescribed gap from another shelf.

The product allotment calculation unit 123 determines whether ending conditions for product allotment draft modification are satisfied (S1000). If the product allotment calculation unit 123 determines that the ending conditions are satisfied (S1000: YES), then the process progresses to step S1200, and if not (S1000: NO), then the process progresses to step S1100. Examples of such ending conditions include the number of times that product allotment modification is to be performed exceeding an upper limit value, a prescribed time elapsing from the start of the product layout design process, or the like.

The product allotment calculation unit 123 modifies the product allotment (S1100). The product allotment calculation unit 123 modifies the product allotment by modifying the allotment of one randomly selected product to a randomly selected shelf or interchanging the allotment to shelves of two randomly selected products, for example, and generates another product allotment draft. However, the product allotment calculation unit 123 confirms whether the size of the product to be allotted to each shelf is less than or equal to the storage size of the shelf in the product allotment draft after modification or interchange, and if the product size exceeds the storage size, then the allotment draft is discarded.

The shelf arrangement calculation unit 125 determines whether ending conditions for product shelf group modification are satisfied (S1200). If the shelf arrangement calculation unit 125 determines that the ending conditions are satisfied, then the process progresses to step S1400, and if not, then the process progresses to step S1300. The following are used as the ending conditions: the number of times that product shelf group modification is to be performed exceeding an upper limit value, a prescribed time elapsing from the start of the product layout design process, or the like.

The shelf arrangement calculation unit 125 modifies the product shelves, which are constituent elements of the product shelf group, and generates a plurality of product shelf drafts (S1300). The shelf arrangement calculation unit 125 generates another product shelf group draft by selecting a prescribed number of shelves from the shelf information table 1300 and adding the shelves to the current product shelf group draft or selecting a prescribed number of shelves from the current product shelf group draft and deleting them, for example. Also, the shelf arrangement calculation unit 125 may generate the product shelf group draft by decreasing the parameter N described in step S100 by a prescribed amount and reselecting shelves by a similar method to step S100.

The total cost calculation unit 126 extracts a product shelf layout draft on the basis of the total cost of the product shelf layout draft generated or modified in the process of steps S100 to S1300 (S1400). The total cost calculation unit 126 may extract a product shelf layout draft in which the total cost is less than a prescribed threshold from among picking operations from the plurality of product shelf layout drafts, extract a prescribed number of product shelf layout drafts in order of lower total cost, or extract only the product shelf layout draft with the lowest total cost. The total cost calculation unit 126 stores some or all of the information of the extracted product shelf layout drafts in the shelf arrangement information table 1170, the product allotment information table 1171, and the total cost information table 1172, respectively, for example.

FIG. 15 shows an example of the picking operation man-hour and resupply operation man-hour calculation processes. The process of steps S601 to S603 is for calculating the picking operation man-hours, and this process is repeated for all rounds included in the delivery performance information table 1110.

The picking operation man-hour calculation unit 121 calculates the motion line distance of each round (S601). Specifically, the picking operation man-hour calculation unit 121 calculates the picking operation motion line distance of each round using the motion line distance between shelves calculated in step S500, the products (group of products) gathered in the round extracted from the delivery performance information table 1110, and the product allotment draft determined in step S200 (if the product allotment has been modified since the initial draft, then step S1100).

The picking operation man-hour calculation unit 121 calculates the picking operation time of each round (S602). The picking operation man-hour calculation unit 121 calculates the picking operation time of the round using the picking operation motion line distance calculated in S500, the delivery amount stored in the delivery performance information table 1110, and parameter information stored in the parameter information storage region 116, for example. The picking operation man-hour calculation unit 121 calculates, as the picking operation time of the round, the sum of the time value attained by dividing the picking motion line distance calculated in S500 by the picking operation movement speed that is parameter information, and the time value attained by multiplying the unit picking operation time that is parameter information by the delivery amount of the product that is delivery performance information.

The picking operation man-hour calculation unit 121 adds the picking operation times for all rounds, and uses this value as the picking operation man-hours for all rounds (S603).

Steps S604 and S605 are a process for calculating the resupply operation man-hours, and this process is performed for all relevant products. The resupply operation man-hour calculation unit 122 calculates the resupply operation time for each product (S604). Specifically, the resupply operation man-hour calculation unit 122 calculates the resupply operation time for each product using the motion line distance information between shelves calculated in step S500, the information on the number of times to perform resupply calculated in step S300, and the product allotment information determined in step S200 (if the product allotment has been modified since the initial draft, then step S1100).

The resupply operation man-hour calculation unit 122 calculates the resupply operation time by the following formula, for example: number of times to perform resupply×((motion line distance from resupply start point, shelf on which each product is stored, and resupply end point/resupply operation movement speed)+unit resupply operation time). Regarding parameters such as the resupply operation movement speed and the unit resupply operation time stored in the parameter information table 1160, different values may be used for resupply operations distinguished between a resupply operation for when the product storage amount has decreased to below the resupply point, and a resupply operation for when the product storage amount is expected to decrease below 0. In step S300, if the number of times to perform the resupply operation is calculated for the distinguished resupply operations, the resupply operation man-hour calculation unit 122 may substitute the different values into the above-mentioned formula, and calculate the resupply operation times of the distinguished resupply operations. Next, the resupply operation man-hour calculation unit 122 adds the resupply operation time for each product to calculate the resupply operation man-hours (S605).

In step S602, the picking operation man-hour calculation unit 121 may set as the number of movements in the round a value attained by adding 1 to the number of shelves included in the shelf group to be cycled through (the 1 to be added indicates the movement to the picking end point), and set as the resupply motion line distance a value attained by multiplying the number of movements in the round by a prescribed coefficient.

The product shelf layout design device 210 can create a product shelf layout in which the picking operation man-hours and the resupply operation man-hours are reduced, and even the operation cost is reduced, by the process shown in FIGS. 13 and 15. The product shelf layout design device 210 includes the arrangement of product shelves in the product shelf layout draft, and calculates the operation man-hours on the basis of the motion line distances for picking and resupply calculated according to this arrangement, thereby calculating the operation cost with high accuracy.

The product shelf layout design device 210 can create a product shelf layout in which the resupply operation man-hours are further reduced, and even the operation cost is further reduced, by calculating the maximum storage amount and the resupply point on the basis of the number of times to perform the resupply operation. Also, the product shelf layout design device 210 selects the product shelf layout design results on the basis of the total cost including the equipment cost and area cost, thereby creating a product shelf layout by which an increase in equipment cost resulting from an increase in the number of shelves, an increase in area resulting from an increase in the area of the picking area, and the like are mitigated, or in other words, the total cost including the operation cost, equipment cost, and area cost is suppressed.

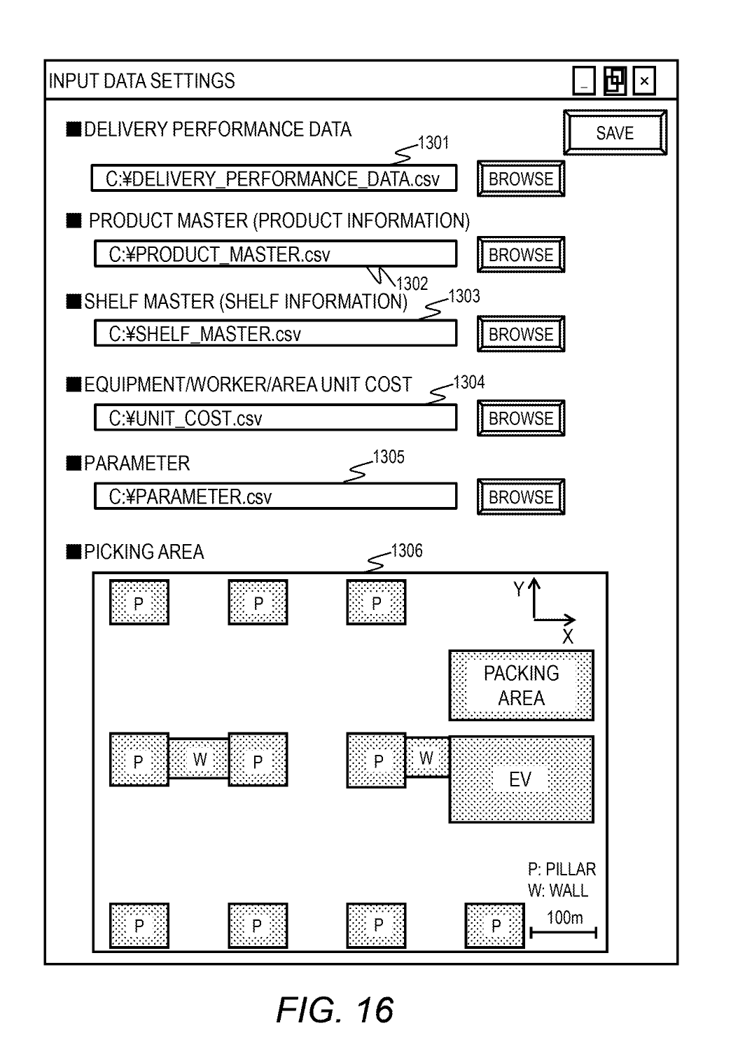

FIG. 16 shows an example of a display screen for setting input data. The display screen is for setting information to be stored in the storage unit 110. The display screen includes input reception regions 1301 to 1306, for example. The input reception region 1301 receives input of delivery performance data to be stored in the delivery performance information storage region 111. The input reception region 1302 receives input of product information to be stored in the product size information storage region 112.

The input reception region 1303 receives input of shelf master information to be stored in the shelf information storage region 113. The input reception region 1304 receives input of unit cost information to be stored in the unit cost information storage region 115. The input reception region 1305 receives input of parameter information to be stored in the parameter information storage region 116.

The input reception region 1306 receives input of picking area information. The input reception region 1306 may receive input of a value to be stored in the picking area information table 1140, or, as shown in FIG. 16, the input reception region 1306 may receive input of picking area information by drawing impassable regions on the screen, for example.

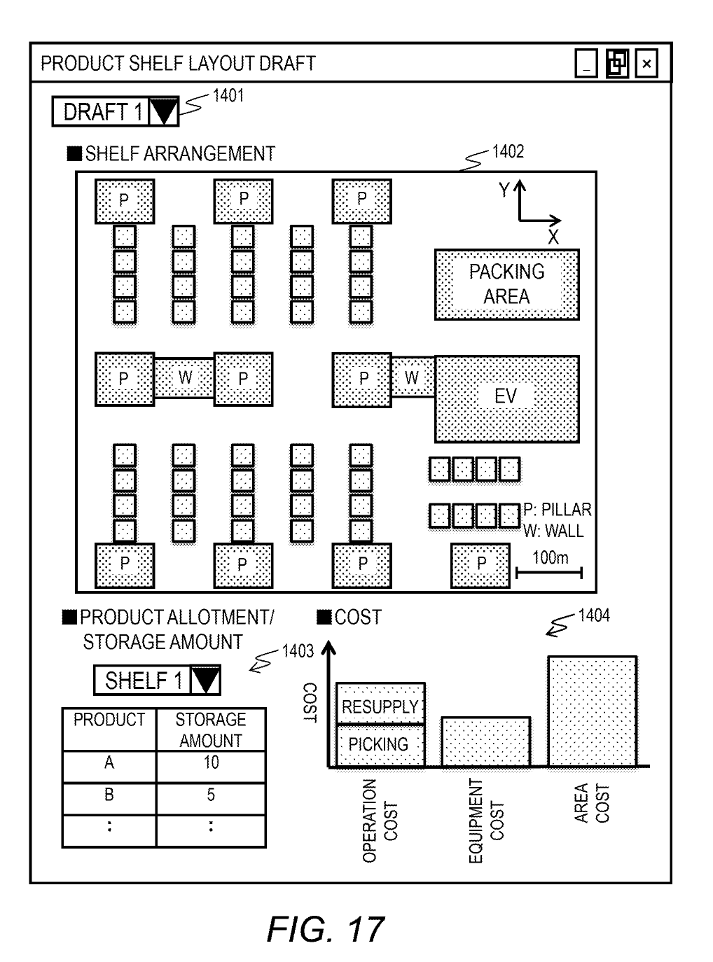

FIG. 17 shows an example of a display screen of a product shelf layout draft. The display screen displays information stored in the product shelf layout draft information storage region 117, for example. The display screen includes, for example, a product shelf layout draft selection region 1401, a shelf arrangement display region 1402, a product allotment/maximum storage amount display region 1403, and a cost display region 1404. The product shelf layout draft selection region 1401 is a region for selecting the product shelf layout draft to be displayed.

The shelf arrangement display region 1402 displays information stored in the shelf arrangement information table 1170. Specifically, the shelf arrangement display region 1402 displays a shelf arrangement in the selected product shelf layout draft, for example. The product allotment/maximum storage amount display region 1403 displays information stored in the product allotment information table 1171. Specifically, the product allotment/maximum storage amount display region 143 displays the product allotment, the maximum storage amount, and the like, for example. The cost display region 1404 displays information stored in the total cost information table 1172. Specifically, the cost display region 1404 displays the operation cost, the equipment cost, and the area cost in the product shelf layout draft, for example.

The product shelf layout design device 210 of the present embodiment uses prior delivery performance to calculate the total cost in each product shelf layout draft, but may calculate the total cost using delivery amount estimation results for each product in each future round, for example. In other words, the delivery performance information table 1110 may store, instead of past delivery performance information, future delivery estimation information inputted by the user or the like, for example.

This invention is not limited to the above-described embodiments but includes various modifications. The above-described embodiments are explained in details for better understanding of this invention and are not limited to those including all the configurations described above.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

What is claimed is:

1. A product shelf layout design device, comprising:
a processor; and
a storage device,
wherein the storage device stores
delivery performance information identifying a delivery date, a round, a product, and a delivery amount,
product size information identifying a product size,
product shelf information identifying a storage size of a product shelf,
picking area information identifying an arrangement in a picking area, and
a parameter that converts a motion line distance to a movement time, and
wherein the processor
generates a product shelf group draft necessary for storing the product, a product allotment draft for the product shelf group draft, and a maximum storage amount and resupply point draft for the product using the delivery performance information over a prescribed period, the product size information, and the product shelf information,
generates a shelf arrangement draft and a motion line distance between shelves for a product shelf group using the product shelf group draft necessary for storing the product, and the picking area information,
generates a plurality of the product shelf layout drafts that are a combination of the product allotment draft, the maximum storage amount and resupply point draft for the product, and the shelf arrangement draft,
calculates, for the product shelf layout draft, a pickup operation time in a delivery performance over the prescribed period using the delivery performance information of the prescribed period, the motion line distance between shelves, and the parameter,
calculates, for the product shelf layout draft, calculate a resupply operation time based on the delivery performance over the prescribed period using the delivery performance information of the prescribed period, the motion line distance between shelves, and the parameter,
calculates operation man-hours using the pickup operation time and the resupply operation time, and
selects a product shelf layout draft to be displayed from among the plurality of product shelf layout drafts using the operation man-hours.

2. The product shelf layout design device according to claim 1, wherein the processor
calculates a number of times to perform the resupply operation on the basis of the storage size of the product shelf and the product size, and
generates the maximum storage amount and resupply point draft for the product using the number of times to perform the resupply operation.

3. The product shelf layout design device according to claim 1,
wherein the picking area information includes impassable region information indicating an impassable region, and
wherein the processor calculates, as the motion line distance between shelves, a motion line distance of a path that does not pass through the impassable region.

4. The product shelf layout design device according to claim 1,
wherein the storage device additionally stores
a man-hour calculation parameter that is information identifying an operation time based on the operation motion line distance, and an operation time based on the number of times to perform picking, and
cost information that is information identifying a man-hour unit cost, and
wherein the processor
calculates the operation man-hours using the operation motion line distance, the delivery performance information, and the man-hour calculation parameter, and
selects the product shelf layout draft to be displayed on the basis of the operation man-hours and the cost information.

5. A method for designing a product shelf layout by a product shelf layout design device,
wherein the product shelf layout design device stores
delivery performance information identifying a delivery date, a round, a product, and a delivery amount,
product size information identifying a product size,
product shelf information identifying a storage size of a product shelf,
picking area information identifying an arrangement in a picking area, and
a parameter that converts a motion line distance to a movement time, and
wherein the method comprising:
generating, by the product shelf layout design device, a product shelf group draft necessary for storing the product, a product allotment draft for the product shelf group draft, and a maximum storage amount and resupply point draft for the product using the delivery performance information over a prescribed period, the product size information, and the product shelf information,
generating, by the product shelf layout design device, a shelf arrangement draft and a motion line distance between shelves for a product shelf group using the product shelf group draft necessary for storing the product, and the picking area information,
generating, by the product shelf layout design device, a plurality of the product shelf layout drafts that are a combination of the product allotment draft, the maximum storage amount and resupply point draft for the product, and the shelf arrangement draft,
calculating, by the product shelf layout design device, for the product shelf layout draft, a pickup operation time in a delivery performance over the prescribed period using the delivery performance information of the prescribed period, the motion line distance between shelves, and the parameter,
calculating, by the product shelf layout design device, for the product shelf layout draft, calculate a resupply operation time based on the delivery performance over the prescribed period using the delivery performance information of the prescribed period, the motion line distance between shelves, and the parameter,
calculating, by the product shelf layout design device, operation man-hours using the pickup operation time and the resupply operation time, and
selecting, by the product shelf layout design device, a product shelf layout draft to be displayed from among the plurality of product shelf layout drafts using the operation man-hours.

6. The method according to claim 5,
wherein the method further comprising:
calculating, by the product shelf layout design device, a number of times to perform the resupply operation on the basis of the storage size of the product shelf and the product size, and
generating, by the product shelf layout design device, the maximum storage amount and resupply point draft for the product using the number of times to perform the resupply operation.

7. The method according to claim 5,
wherein the picking area information includes impassable region information indicating an impassable region, and
wherein the method further comprising calculating, by the product shelf layout design device, as the motion line distance between shelves, a motion line distance of a path that does not pass through the impassable region.

8. The method according to claim 5,
wherein the product shelf layout design device additionally stores
a man-hour calculation parameter that is information identifying an operation time based on the operation motion line distance, and an operation time based on the number of times to perform picking, and
cost information that is information identifying a man-hour unit cost, and
wherein the method further comprising:
calculating, by the product shelf layout design device, the operation man-hours using the operation motion line distance, the delivery performance information, and the man-hour calculation parameter, and
selecting, by the product shelf layout design device, the product shelf layout draft to be displayed on the basis of the operation man-hours and the cost information.
